(19) United States
(12) Patent Application Publication
(10) Pub. No.: US 2012/0273115 A1
(43) Pub. Date: Nov. 1, 2012

(54) SEALANT APPLICATOR, AND METHOD FOR APPLYING SEALANT AND METHOD FOR ASSEMBLING AIRCRAFT USING THE SEALANT APPLICATOR

(76) Inventors: Akihito Suzuki, Minato-ku (JP); Koichi Nakamura, Minato-ku (JP); Akira Kono, Minato-ku (JP); Akira Ikada, Minato-ku (JP); Toshiyuki Funato, Minato-ku (JP); Yusuke Ikeda, Minato-ku (JP); Takahiro Inagaki, Minato-ku (JP)

(21) Appl. No.: 13/433,613

(22) Filed: Mar. 29, 2012

(30) Foreign Application Priority Data
Apr. 28, 2011 (JP) 2011-102141

(51) Int. Cl. B05D 1/18; B32B 37/12; B05C 3/09

(52) U.S. Cl. 156/92; 118/429; 427/430.1

(57) ABSTRACT

Provided is a sealant applicator which enables an operator to uniformly apply a given amount of sealant to a fastener in a short time regardless of the skill of the operator. The sealant applicator according to the present invention includes: an inner space defined by a substantially cylindrical inner surface that receives a fastener in an axial direction from one end; and a concave-convex portion formed in the inner surface and composed of a convex portion to be located adjacent to the fastener and a concave portion to be located apart from the fastener.

### CROSS-REFERENCE TO RELATED APPLICATIONS

This application is based on Japanese Patent Application No. 2011-102141, the contents of which are incorporated herein by reference.

### TECHNICAL FIELD

The present invention relates to a sealant applicator, and a method for applying a sealant and a method for assembling an aircraft using the sealant applicator.

### BACKGROUND ART

Aircraft are manufactured by assembling aircraft assemblies such as a main wing assembly, a tail wing assembly, and a fuselage assembly which are separately manufactured.

In the aircraft assemblies, a skin forming an outer shape is reinforced from inside by a structural member. The structural member is a frame member formed in a grid shape.

The skin and the structural member located inside the skin are joined together by a fastener as disclosed in Patent Literature 1, for example.

At this point, a sealant is interposed between the fastener and a mounting hole in the skin and the structural member to ensure airtightness.

In the technique disclosed in Patent Literature 1, after a sealant made of resin is applied to the mounting hole, the fastener is inserted into the mounting hole to join the skin and the structural member.

Besides the above technique, there is also a popular method of applying the sealant made of resin to the fastener, and inserting the fastener into the mounting hole.

In general, operators manually apply the sealant made of resin to the fastener by using a brush since the bristle is chemically stable, hardly dissolved in a solvent, and inexpensive.

### CITATION LIST

### Patent Literature

### {PTL 1}

Japanese Unexamined Patent Application, Publication No. 2009-227166

### SUMMARY OF INVENTION

### Technical Problem

However, when operators use a brush to apply the sealant to the fastener, it takes time to thinly and uniformly apply the sealant due to its high viscosity. The quality also varies depending on each operator.

Moreover, it is difficult to take an appropriate amount of sealant with high viscosity by the brush. Thus, an excess amount of sealant is inevitably applied. The excess sealant thereby sticks out from the fastener after mounting, so that it takes time to perform a cleaning operation to remove the excess sealant.

In view of such circumstances, it is an object of the present invention to provide a sealant applicator which enables an operator to uniformly apply a given amount of sealant to a fastener in a short time regardless of the skill of the operator, and a method for applying a sealant and a method for assembling aircraft parts using the sealant applicator.

### Solution to Problem

To achieve the above object, the present invention employs the following solutions.

That is, a first aspect of the present invention is a sealant applicator including: an inner space defined by a substantially cylindrical inner surface that receives a fastener in an axial direction from one end; and a concave-convex portion formed in the inner surface and composed of a convex portion to be located adjacent to the fastener and a concave portion to be located apart from the fastener.

The sealant applicator according to the present aspect includes: the inner space defined by the substantially cylindrical inner surface that receives the fastener in the axial direction from the one end; and the concave-convex portion formed in the inner surface and composed of the convex portion to be located adjacent to the fastener and the concave portion to be located apart from the fastener. Thus, the fastener is inserted from the one end of the inner space, and can be thereby placed within the inner space such that a predetermined gap is formed between the convex portion to be located adjacent to the fastener and the fastener.

For example, when a sealant with high viscosity is fed from the other end portion of the inner space after the fastener is placed as described above, the sealant passes through the gap formed between the inner surface and the fastener to the one end side. Since there is a larger gap in the concave portion, resistance to the sealant is small. The sealant can thereby move quickly. After the sealant covers an entire application surface of the fastener, the fastener is pulled out of the inner space. The sealant is thereby restricted by the convex portion and removed. Accordingly, the sealant can be applied to the application surface of the fastener with a substantially uniform thickness substantially corresponding to the predetermined gap between the convex portion and the fastener.

For example, when a relatively large amount of sealant is applied to the surface of the fastener and the fastener is inserted into the inner space, the fastener is inserted with the sealant being restricted by the convex portion and removed. After that, the fastener is pulled out of the inner space. The sealant is thereby restricted by the convex portion and removed. Accordingly, the sealant can be applied to the application surface of the fastener with a substantially uniform thickness substantially corresponding to the predetermined gap between the convex portion and the fastener.

As described above, with the present aspect, a given amount of sealant can be uniformly applied to the fastener in a short time regardless of the skill of an operator.

Since the application amount of the sealant substantially corresponds to the predetermined gap between the convex portion and the fastener, the application amount of the sealant can be adjusted by adjusting the predetermined gap. Thus, the application amount of the sealant can be limited to a required amount, in other words, the excess sealant can be minimized. Accordingly, the sealant can be saved, and a cleaning operation for removing the excess sealant that sticks out from the fastener after mounting can be reduced.

In the above aspect, the concave-convex portion may be composed of a plurality of longitudinal grooves formed in the inner surface so as to extend in the axial direction of the inner space.

Since the concave-convex portion is composed of the plurality of longitudinal grooves formed in the inner surface so as to extend in the axial direction of the inner space, a longitudinal groove portion forms the concave portion, and a portion between adjacent longitudinal grooves forms the convex portion.

The concave portion is arranged in the inner surface so as to extend in the axial direction of the inner space. Thus, for example, when the sealant is injected from the other end side after the fastener is placed, it takes less time for the sealant to cover the entire application surface of the fastener. Accordingly, the sealant can be applied to the fastener in a short time.

The sealant remains inside the longitudinal groove as the concave portion after the fastener is pulled out. Since the longitudinal groove is arranged along the entire axial direction of the inner surface, the remaining sealant comes into contact with an entire surface of a next fastener when the next fastener is inserted thereto. Accordingly, even when the sealant is not supplied from the other end, the sealant can be applied to the fastener.

In the above aspect, the concave-convex portion may be composed of a plurality of lateral grooves formed in the inner surface over the entire circumference in a direction substantially perpendicular to the axial direction of the inner space.

Since the concave-convex portion is composed of the plurality of lateral grooves formed in the inner surface over the entire circumference in the direction substantially perpendicular to the axial direction of the inner space, a lateral groove portion forms the concave portion, and a portion between adjacent lateral grooves forms the convex portion.

Since the concave portion is formed in the inner surface over the entre circumference in the direction substantially perpendicular to the axial direction of the inner space, the convex portion is also formed over the entire circumference. Accordingly, the sealant applied to the fastener is restricted by the convex portion over the entire circumference and thereby removed. Thus, the sealant can be applied to the application surface of the fastener with a more uniform thickness.

In the above aspect, the concave-convex portion may be composed of one or a plurality of spiral grooves formed in the inner surface so as to be inclined with respect to the axial direction of the inner space.

Since the concave-convex portion is composed of the one or the plurality of spiral grooves formed in the inner surface so as to be inclined with respect to the axial direction of the inner space, a spiral groove portion forms the concave portion, and a portion between adjacent spiral grooves forms the convex portion.

In this case, the spiral grooves are expected to produce the combined effects of the longitudinal grooves and the lateral grooves depending on the arrangement of the spiral grooves.

A second aspect of the present invention is a method for applying a sealant including: inserting from one end side a fastener into a sealant applicator including an inner space defined by a substantially cylindrical inner surface that receives the fastener in an axial direction from the one end, and a concave-convex portion formed in the inner surface and composed of a convex portion to be located adjacent to the fastener and a concave portion to be located apart from the fastener, and thereby placing the fastener within the inner space; filling the inner space with a sealant; and pulling the fastener out of the sealant applicator after the sealant covers an entire application surface of the fastener.

In the method for applying a sealant according to the present aspect, the fastener is inserted from the one end of the inner space of the sealant applicator, and thereby placed within the inner space such that a predetermined gap is formed between the convex portion to be located adjacent to the fastener and the fastener. When a sealant with high viscosity is fed from the other end portion of the inner space in the above state, the sealant passes through the gap formed between the inner surface and the fastener to the one end side. Since there is a larger gap in the concave portion, resistance to the sealant is small. The sealant can thereby move quickly. After the sealant covers the entire application surface of the fastener, the fastener is pulled out of the inner space. The sealant is thereby restricted by the convex portion and removed. Accordingly, the sealant can be applied to the application surface of the fastener with a substantially uniform thickness substantially corresponding to the predetermined gap between the convex portion and the fastener.

As described above, with the method for applying a sealant according to the present aspect, a given amount of sealant can be uniformly applied to the fastener in a short time regardless of the skill of an operator.

Since the application amount of the sealant substantially corresponds to the predetermined gap between the convex portion and the fastener, the application amount of the sealant can be adjusted by adjusting the predetermined gap. Thus, the application amount of the sealant can be limited to a required amount, in other words, the excess sealant can be minimized. Accordingly, the sealant can be saved, and a cleaning operation for removing the excess sealant that sticks out from the fastener after mounting can be reduced.

A third aspect of the present invention is a method for applying a sealant including: applying a larger amount of sealant than a minimum amount required so as to cover an entire application surface of a fastener to the surface of the fastener; inserting the fastener into a sealant applicator including an inner space defined by a substantially cylindrical inner surface that receives the fastener in an axial direction, and a concave-convex portion formed in the inner surface and composed of a convex portion to be located adjacent to the fastener and a concave portion to be located apart from the fastener; and pulling the fastener out of the sealant applicator.

In the method for applying a sealant according to the present aspect, when the larger amount of sealant than the minimum amount required so as to cover the entire application surface of the fastener is applied to the surface of the fastener and the fastener is inserted into the inner space of the sealant applicator, the fastener is inserted with the sealant being restricted by the convex portion and removed. After the fastener is inserted such that the entire application surface is located within the inner space, the fastener is pulled out of the inner space. The sealant is thereby restricted by the convex portion and removed. Accordingly, the sealant can be applied to the application surface of the fastener with a substantially uniform thickness substantially corresponding to the predetermined gap between the convex portion and the fastener.

As described above, with the method for applying a sealant according to the present aspect, a given amount of sealant can be uniformly applied to the fastener in a short time regardless of the skill of an operator.

Since the application amount of the sealant substantially corresponds to the predetermined gap between the convex portion and the fastener, the application amount of the sealant can be adjusted by adjusting the predetermined gap. Thus, the application amount of the sealant can be limited to a required amount, in other words, the excess sealant can be minimized. Accordingly, the sealant can be saved, and a cleaning operation for removing the excess sealant that sticks out from the fastener after mounting can be reduced.

A fourth aspect of the present invention is a method for assembling an aircraft including: assembling an aircraft by joining parts together by a fastener to which a sealant is applied by use of a sealant applicator according to the first aspect.

In the method for assembling an aircraft according to the present aspect, a given amount of sealant can be uniformly applied to the fastener in a short time regardless of the skill of an operator. Accordingly, a high-quality aircraft can be manufactured, and an assembling time can be shortened.

### Advantageous Effects of Invention

With the present invention, a given amount of sealant can be uniformly applied to the fastener in a short time regardless of the skill of an operator.

### BRIEF DESCRIPTION OF DRAWINGS

FIG. 1 is a perspective view illustrating the configuration of a main wing assembled by using a sealant applicator according to one embodiment of the present invention.

FIG. 2 is a sectional view illustrating the configuration of a fastening portion between an upper skin and a stringer in FIG. 1.

FIG. 3 is a side view showing a fastener in FIG. 2.

FIG. 4 is a perspective view showing the sealant applicator according to one embodiment of the present invention.

FIG. 5 is a sectional view taken along X-X in FIG. 4.

FIG. 6 is a sectional view showing a usage state of the sealant applicator according to one embodiment of the present invention.

FIG. 7 is a partial longitudinal sectional view showing a modification of the sealant applicator according to one embodiment of the present invention.

FIG. 8 is a partial longitudinal sectional view showing a modification of the sealant applicator according to one embodiment of the present invention.

FIG. 9 is a side view showing a fastener having a different shape.

FIG. 10 is a perspective view showing a sealant applicator for applying a sealant to the fastener in FIG. 9.

### DESCRIPTION OF EMBODIMENTS

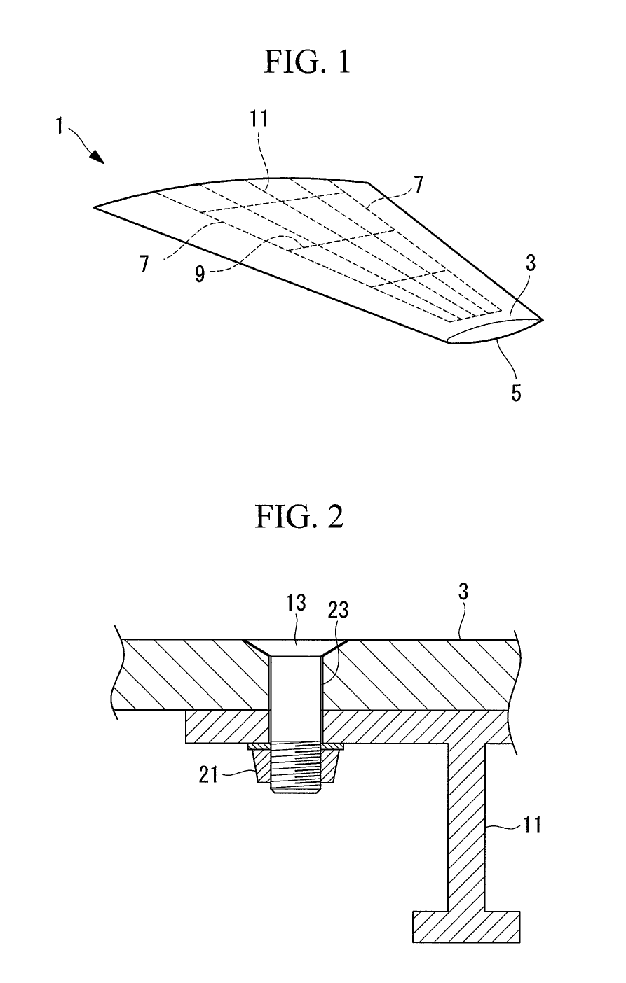

In the following, a sealant applicator and a method for applying a sealant using the sealant applicator according to one embodiment of the present invention will be described in detail based on FIGS. 1 to 6.

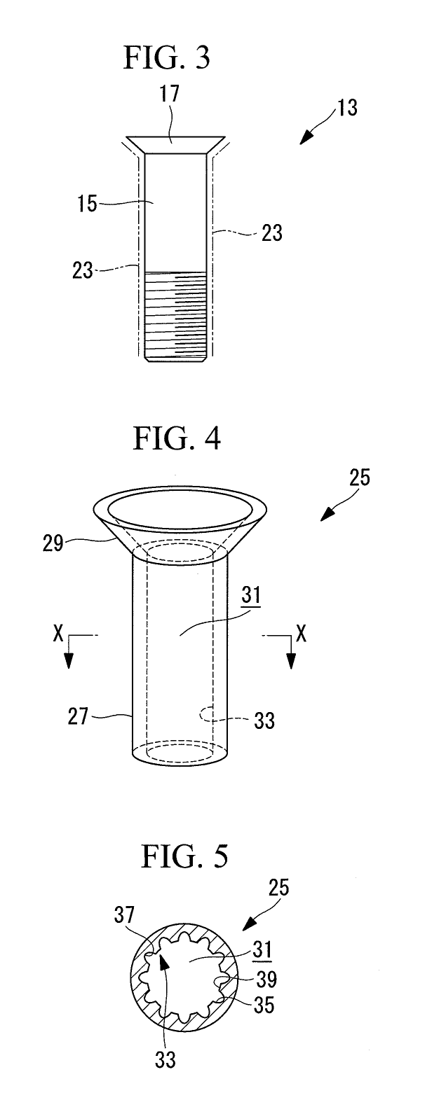

FIG. 1 is a perspective view illustrating the configuration of a main wing assembled by using the sealant applicator according to one embodiment of the present invention. FIG. 2 is a sectional view illustrating the configuration of a fastening portion between an upper skin and a stringer in FIG. 1. FIG. 3 is a side view showing a fastener in FIG. 2.

An aircraft is manufactured by integrally assembling a plurality of aircraft assemblies such as a main wing assembly, a tail wing assembly, and a fuselage assembly which are separately manufactured. The structure of a main wing 1 will be described below.

The main wing 1 mainly includes an upper skin 3, a lower skin 5, a spar 7, a rib 9, and a stringer 11.

The upper skin 3 and the lower skin 5 are thin plates that constitute the outer shape of the main wing 1. Together with the spar 7, the rib 9, and the stringer 11, the upper skin 3 and the lower skin 5 partially receive a tensile load or a compressive load acting on the main wing 1.

The upper skin 3 is a thin plate that constitutes an upper surface of the main wing 1. The lower skin 5 is a thin plate that constitutes a lower surface of the main wing 1.

The upper skin 3 and the lower skin 5 are made of carbon fiber reinforced plastic (CFRP) using epoxy resin as a base material and carbon fiber as reinforcement fiber, for example. The upper skin 3 and the lower skin 5 may be also made of metal such as aluminum alloy.

The spar 7 is a structural member that extends in a wingspan direction of the main wing 1, and a member arranged between the upper skin 3 and the lower skin 5 as shown in FIG. 1. In the present embodiment, the spar 7 is arranged in each of the front and the back of the main wing 1.

The stringer 11 is a structural member that extends in the wingspan direction of the main wing 1 between the pair of spars 7 as shown in FIG. 1. The stringer 11 reinforces the strength of the spar 7.

The spar 7 and the stringer 11 transmit a force such as a bending force and a torsional force acting on the main wing 1 in a front-back direction or a vertical direction to an aircraft fuselage (not shown) to which the main wing 1 is mounted.

The rib 9 is a structural member that extends in a wing chord direction of the main wing 1 and arranged between the upper skin 3 and the lower skin 5 as shown in FIG. 1. In other words, the rib 9 is a structural member that extends in a direction substantially perpendicular to the spar 7 and the stringer 11, and a plate-like member formed in a sectional shape of the main wing 1.

The spar 7, the rib 9, and the stringer 11 are made of metal such as aluminum alloy. The spar 7, the rib 9, and the stringer 11 may be also partially made of metal, or entirely made of fiber reinforced resin such as CFRP.

The spar 7, the stringer 11, and the rib 9 are fastened to the upper skin 3 and the lower skin 5 by using a fastener 13 made of metal. The fastener 13 is made of aluminum alloy or titanium, for example.

The fastener 13 includes a shank portion 15 extending in a cylindrical shape, and a head portion 17 arranged at one end of the shank portion 15 as shown in FIG. 3. The shank portion 15 has a diameter of about 6.75 mm, for example.

The head portion 17 has a conical frustum shape. A small-diameter portion of the head portion 17 is connected to the shank portion 15 having substantially the same diameter. A male thread 19 is formed in a portion of the shank portion 15 on the opposite side from the head portion 17.

As shown in FIG. 2, the fastener 13 is arranged such that the shank portion 15 is inserted into a through hole formed in the upper skin 3 and the stringer 11 and the head portion 17 is embedded in the upper skin 3.

The shank portion 15 is provided so as to project from the stringer 11. A nut 21 is threadedly engaged with the male thread 19 of the shank portion 15. The nut 21 moves toward the stringer 11, so that the fastener 13 fastens the upper skin 3 and the stringer 11 together.

When the upper skin 3 and the stringer 11 are fastened together, a gap is provided between the shank portion 15 of the fastener 13 and the through hole provided in the upper skin 3 and the stringer 11 (clearance fit). It is thus necessary to ensure airtightness of the portion.

Therefore, a sealant 23 is interposed between the shank portion 15 of the fastener 13 and the through hole provided in the upper skin 3 and the stringer 11.

As a material of the sealant 23, polysulfide, specifically, Pro-Seal 890 Class C manufactured by PPG Industries is employed.

The sealant 23 may be also made of polythioether, silicone rubber, polyurethane, or epoxy resin.

To join the upper skin 3 and the stringer 11 by the fastener 13, the fastener 13 is inserted into the through hole after the sealant 23 is applied to a side surface of the shank portion 15 of the fastener 13 and a lower portion of the head portion 17 as shown in FIG. 3.

In the following, a sealant applicator 25 used to apply the sealant 23 to the fastener 13 will be described.

FIG. 4 is a perspective view showing the sealant applicator 25. FIG. 5 is a sectional view taken along X-X in FIG. 4.

The sealant applicator 25 includes a shank portion receiving portion 27 having a hollow cylindrical shape, and a head portion receiving portion 29 arranged at one end of the shank portion receiving portion 27 as shown in FIG. 4.

The head portion receiving portion 29 has a hollow conical frustum shape. A small-diameter portion of the head portion receiving portion 29 is connected to the shank portion receiving portion 27 having substantially the same diameter.

An inner space 31 having an axially-penetrating substantially cylindrical shape is formed inside the shank portion receiving portion 27 and the head portion receiving portion 29.

A plurality of longitudinal grooves 35 are formed in an inner surface 33 defining the inner space 31 at an interval in a circumferential direction so as to extend in the axial direction continuously along the entire length as shown in FIG. 5. The longitudinal grooves 35 have a depth of 0.50 mm, for example.

Each of the longitudinal grooves 35 forms a concave portion 37, and the inner surface 33 remaining with no groove being formed therein between the adjacent longitudinal grooves 35 forms a convex portion 39.

The inner surface 33, i.e., a cylindrical shape formed by the convex portions 39 has a diameter of about 7 mm, for example. Thus, a difference between the diameters of the cylindrical shape formed by the convex portions 39 and the shank portion 15, that is, a gap is 0.25 mm (0.125 mm on one side).

A distal end portion of a sealant gun 41 that ejects the sealant can be mounted to the shank portion receiving portion 27 on the opposite side from the head portion receiving portion 29. For example, to mount the sealant gun 41, a male thread is formed in the outer circumference of the shank portion receiving portion 27. A female thread corresponding to the male thread is also formed in the distal end portion of the sealant gun 41. The male thread and the female thread are threadedly engaged with each other.

A sealant application method for applying the sealant 23 to the fastener 13 by use of the sealant applicator 25 having the above configuration will be described.

The sealant gun 41 is mounted to the other end of the shank portion receiving portion 27 of the sealant applicator 25.

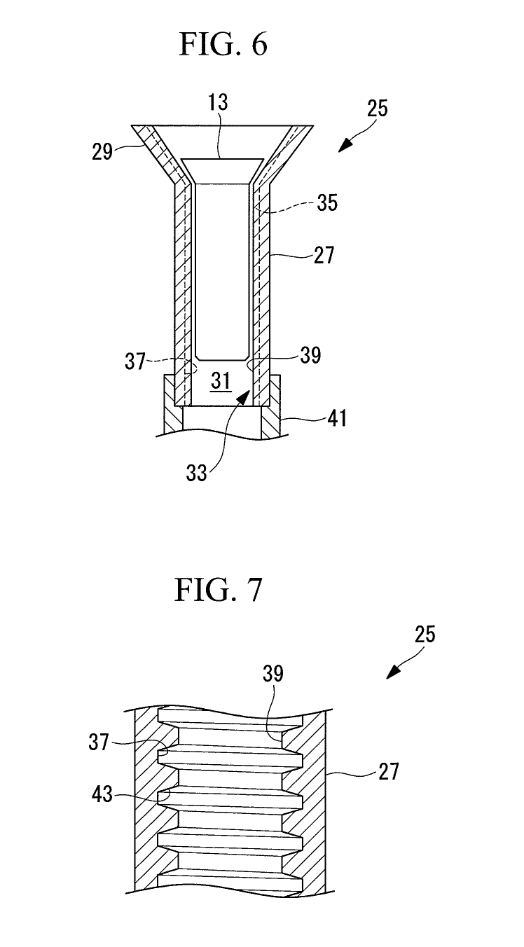

The fastener 13 is inserted into the inner space 31 from the head portion receiving portion 29 at the one end with the shank portion 15 being oriented toward the sealant applicator 25. The fastener 13 is inserted to a position where the head portion 17 comes into abutment against the inner surface 33 of the head portion receiving portion 29 as shown in FIG. 6. At this point, a distance between an outer circumferential surface of the shank portion 15 and the convex portion 39, that is, a gap is about 0.125 mm, and a distance between the outer circumferential surface of the shank portion 15 and a bottom portion of the concave portion 37, that is, a gap is about 0.625 mm.

When the sealant is ejected from the sealant gun 41 in the above state, the inner space 31 is filled with the sealant. The sealant further moves toward the head portion 17 through the gap between the inner surface 33 and the shank portion 15.

Since there is a larger gap between the concave portion 37 and the shank portion 15, resistance to the sealant is small. The sealant can thereby move quickly. Moreover, since the concave portion 37 continuously exists in the axial direction, the sealant more easily moves in the axial direction. Accordingly, it takes less time for the sealant to cover an entire application surface of the fastener 13.

After the sealant covers the entire application surface of the fastener 13, the fastener 13 is pulled out of the inner space 31. The sealant is thereby restricted by the convex portion 39 and removed. Accordingly, the sealant can be applied to the application surface of the fastener 13 with a substantially uniform thickness substantially corresponding to the gap between the convex portion 39 and the fastener 13.

As described above, with the present aspect, a given amount of sealant can be uniformly applied to the fastener 13 in a short time regardless of the skill of an operator.

Since the application amount of the sealant also substantially corresponds to the predetermined gap between the convex portion 39 and the fastener 13, the application amount of the sealant can be adjusted by adjusting the predetermined gap. Thus, the application amount of the sealant can be limited to a required amount, in other words, the excess sealant can be minimized. Accordingly, the sealant can be saved, and a cleaning operation for removing the excess sealant that sticks out from the fastener 13 after mounting can be reduced.

The sealant remains inside the concave portion 37 after the fastener 13 is pulled out. Since the concave portion 37 is arranged along the entire axial direction of the inner surface 33, the remaining sealant comes into contact with an entire surface of a next fastener 13 when the next fastener 13 is inserted thereto. Accordingly, even when the sealant is not supplied from the sealant gun 41, the sealant can be applied to the fastener 13.

In the present embodiment, the concave portion 37 and the convex portion 39 are composed of the longitudinal grooves 35 formed in the inner surface 33 so as to extend in the axial direction. However, the formation of the concave portion 37 and the convex portion 39 is not limited thereto.

For example, as shown in FIG. 7, a plurality of lateral grooves 43 may be formed in the inner surface 33 at an interval in the axial direction over the entire circumference in a direction substantially perpendicular to the axial direction of the inner space 31. The concave portion 37 and the convex portion 39 may be thereby formed.

In this case, since the concave portion 37 is formed in the inner surface 33 over the entire circumference in the direction substantially perpendicular to the axial direction of the inner space 31, the convex portion 39 is also formed over the entire circumference. Accordingly, the sealant applied to the fastener 13 is restricted by the convex portion 39 over the entire circumference and thereby removed. Thus, the sealant can be applied to the application surface of the fastener 13 with a more uniform thickness.

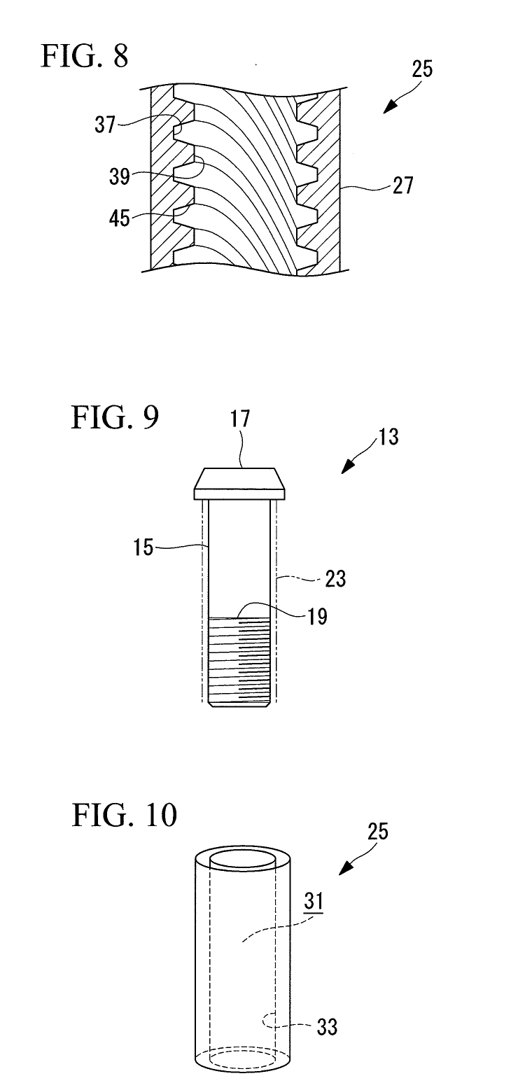

Also, as shown in FIG. 8, one or a plurality of spiral grooves 45 may be formed in the inner surface 33 so as to be inclined with respect to the axial direction of the inner space 31. The concave portion 37 and the convex portion 39 may be thereby formed.

In this case, the spiral grooves 45 are expected to produce the combined effects of the longitudinal grooves 39 and the lateral grooves 43 depending on the arrangement of the spiral grooves 45.

The formation of the concave portion 37 and the convex portion 39 is not limited to the longitudinal grooves 35, the lateral grooves 43, and the spiral grooves 45.

A sealant application test was performed on the sealant applicator 25 having the configuration according to the present embodiment described above.

In Example 1, the sealant applicator 25 having the longitudinal grooves was employed. In Example 2, the sealant applicator 25 having the lateral grooves was employed. In Comparative Example, the sealant applicator 25 having no groove was employed.

In all of the sealant applicators 25, the interval between the convex portion 39 (the inner surface 33 in Comparative Example) and the fastener 13 was the same.

Evaluation items include application unevenness, application time, and re-application. As the application unevenness, a variation in the thickness of the applied sealant is evaluated. The application time is a time to complete the application. As the re-application, whether the sealant can be applied in second or subsequent applications without supplying the sealant is evaluated.

Table 1 shows the results of the sealant application test. The results are classified in A to D in the descending order of performance.

TABLE 1

| | | | Appli- | | |
|---|---|---|---|---|---|
| | | Application | cation | Re- | |
| | Groove type | unevenness | time | application | Total |
| Example 1 | Longitudinal | B | A | B | A |
| | groove | | | | |
| Example 2 | Lateral | A | C | C | B |
| | groove | | | | |
| Comparative | No groove | B | C | D | C |
| Example | | | | | |

The sealant applicators 25 of Examples 1 and 2 can be evaluated to be superior to the sealant applicator 25 of Comparative Example with no groove, that is, in which the concave-convex portion is not formed.

Particularly, the sealant applicator 25 of Example 1 can effectively shorten the application time, and the sealant applicator 25 of Example 2 can effectively reduce the application unevenness.

Although the sealant is fed by using the sealant gun 41 in the above method for applying a sealant, the method for feeding the sealant is not limited thereto, and an appropriate method may be employed.

For example, a lid having a hole is mounted on the sealant stored in a cup (a sealant storage container). The other end of the sealant applicator 25 is pressed against the lid to pressurize the lid. The lid is thereby pressed down, so that the sealant is squeezed from the hole and supplied into the sealant applicator 25 from the other end. At this point, the hole may be provided in a projecting state, and a female thread may be formed therein and threadedly engaged with the male thread 19 of the sealant applicator 25.

The sealant may be also put into a bag made of resin (for example, polypropylene). The top of the bag may be attached to the shank portion receiving portion 27 of the sealant applicator 25. The sealant may be squeezed out by pressurizing the bag to thereby supply the sealant.

Although the sealant is supplied after the fastener 13 is mounted to the sealant applicator 25 in the above method for applying a sealant, the present invention is not limited thereto.

For example, the fastener 13 to which a larger amount of sealant than a minimum amount required so as to cover the entire application surface is applied may be inserted into the inner space 31 of the sealant applicator 25.

In this case, the fastener 13 is inserted with the sealant being restricted by the convex portion 39 and removed. After the fastener 13 is inserted such that the entire application surface is located within the inner space 31, the fastener 13 is pulled out of the inner space 31. The sealant is thereby restricted by the convex portion 39 and removed. Accordingly, the sealant can be applied to the application surface of the fastener 13 with a substantially uniform thickness substantially corresponding to the predetermined gap between the convex portion 39 and the fastener 13.

The method for applying a sealant can also produce the same effects as the method for applying a sealant described above.

As described above, the fastener 13 where the sealant having a predetermined thickness is applied by using the sealant applicator 25 is used to join the upper skin 3 and the lower skin 5 with the structural members such as the spar 7, the rib 9, and the stringer 11, for example. Aircraft assemblies such as a main wing assembly, a tail wing assembly, and a fuselage assembly are thereby assembled.

An aircraft is manufactured by assembling the aircraft assemblies such as a main wing assembly, a tail wing assembly, and a fuselage assembly.

Since the fastener 13 has various shapes and sizes, the sealant applicator 25 is formed corresponding thereto.

For example, the fastener 13 may have a cylindrical shape whose head portion 17 is tapered as shown in FIG. 9. The sealant 23 is applied only to the circumference of the shank portion 15 of the fastener 13.

Thus, the sealant applicator 25 for applying the sealant thereto has a hollow cylindrical shape as shown in FIG. 10. The concave portion 37 and the convex portion 39 described above are formed in the inner surface 33 defining the inner space 31 of the sealant applicator 25.

The present invention is not limited to the embodiment described above, and various changes may be made without departing from the scope of the present invention. For example, the sealant may not be fed from the other end side of the inner space, but a sealant flow passage may be provided inside the shank portion receiving portion 27 to feed the sealant from a plurality of flow passage outlets opened in an inner wall surface of the shank portion receiving portion 27.

1. A sealant applicator comprising:
an inner space defined by a substantially cylindrical inner surface that receives a fastener in an axial direction from one end; and
a concave-convex portion formed in the inner surface and composed of a convex portion to be located adjacent to the fastener and a concave portion to be located apart from the fastener.

2. The sealant applicator according to claim 1, wherein the concave-convex portion is composed of a plurality of longitudinal grooves formed in the inner surface so as to extend in the axial direction of the inner space.

3. The sealant applicator according to claim 1, wherein the concave-convex portion is composed of a plurality of lateral grooves formed in the inner surface over an entire circumference in a direction substantially perpendicular to the axial direction of the inner space.

4. The sealant applicator according to claim 1, wherein the concave-convex portion is composed of one or a plurality of spiral grooves formed in the inner surface so as to be inclined with respect to the axial direction of the inner space.

5. A method for applying a sealant comprising:
inserting from one end side a fastener into a sealant applicator including an inner space defined by a substantially cylindrical inner surface that receives the fastener in an axial direction from the one end, and a concave-convex portion formed in the inner surface and composed of a convex portion to be located adjacent to the fastener and a concave portion to be located apart from the fastener, and thereby placing the fastener within the inner space;
filling the inner space with a sealant; and pulling the fastener out of the sealant applicator after the sealant covers an entire application surface of the fastener.

6. A method for applying a sealant comprising:
applying a larger amount of sealant than a minimum amount required so as to cover an entire application surface of a fastener to the surface of the fastener;
inserting the fastener into a sealant applicator including an inner space defined by a substantially cylindrical inner surface that receives the fastener in an axial direction, and a concave-convex portion formed in the inner surface and composed of a convex portion to be located adjacent to the fastener and a concave portion to be located apart from the fastener; and pulling the fastener out of the sealant applicator.

7. A method for assembling an aircraft comprising:
assembling an aircraft by joining parts together by a fastener to which a sealant is applied by use of a sealant applicator according to claim 1.
